(19) United States
(12) Patent Application Publication
(10) Pub. No.: US 2006/0032954 A1
(43) Pub. Date: Feb. 16, 2006

(54) Stripping device for recycled aggregate

(76) Inventors: Ho Goon Lee, Yangju-Si (KR); Chan Jin Park, Seoul (KR)

Correspondence Address: PARK LAW FIRM, 3255 WILSHIRE BLVD, SUITE 1110, LOS ANGELES, CA, 90010, US

(21) Appl. No.: 11/116,785

(22) Filed: Apr. 18, 2005

(30) Foreign Application Priority Data
Jul. 29, 2004 (KR) 10-2004-0059972

(51) Int. Cl. B02C 17/02; B07B 13/00; B07C 7/00

(52) U.S. Cl. 241/74

(57) ABSTRACT

A stripping device for recycled aggregate strips recycled aggregate, improving the quality of the recycled aggregate that is produced through a construction-waste processing operation. The stripping device includes a hopper into which the recycled aggregate is input, a casing, a rotary drum, drive means, and support legs. The casing includes an inlet hole provided at a predetermined position on the casing so that the aggregate dropping through the hopper takes into the inlet hole, an outlet hole is positioned at opposite from the inlet hole so that the recycled aggregate is discharged through the outlet hole, and uneven part provided on an inner circumferential surface of the casing. The rotary drum is installed in the casing, and includes a feed screw formed around it, which allows rotating and feeding the recycled aggregate. The drive serves to drive the rotary drum. The support legs serve to support the casing.

### CLAIMING FOREIGN PRIORITY

The applicant claims and requests a foreign priority, through the Paris Convention for the Protection of Industry Property, based on patent applications filed in Republic of Korea (South Korea) with the filing date of Jul. 29, 2004 with Korean Patent Application No. 10-2004-0059972 by the applicants. (See the attached Declaration)

### BACKGROUND OF THE INVENTION

1. Field of the Invention

The present invention relates generally to a stripping device for recycled aggregate. More particularly, the present invention relates to a stripping device for recycled aggregate, which strips recycled aggregate, thus improving the quality of the recycled aggregate which is produced through a construction-waste processing operation.

2. Description of the Related Art

In order to protect the environment and recycle resources, waste produced by dismantling structures or buildings is collected at a predetermined spot without being buried. Afterwards, a waste processing operation is carried out to provide resources of good quality. Particularly, recycled aggregate of construction waste has been increasingly used, as many buildings are dismantled due to reconstruction activity in towns and the country.

The schematic processing operation of construction waste is as follows. The collected construction waste is primarily crushed by a crusher, and iron scraps are separated from the construction waste by a magnetic separator, prior to the waste being discharged to the outside. Thereafter, impurities including earth and sand are separated from the waste by the blowing and rotating operations, prior to the waste being discharged to the outside. Afterwards, unusable wood and various kinds of sludge are separated from the waste by a VIB screen. Subsequently, other impurities are removed from the waste by a high-pressure water-jet operation. Thereafter, a secondary crushing operation and/or a third crushing operation are executed by a second crusher and/or a third crusher, thus providing a grain shaped recycled aggregate. Further, various sizes of recycled aggregate are obtained by a sorter.

However, although recycled aggregate is obtained through the above-mentioned process, fine powder, such as cement mortar or impurities, remains on the surface of the recycled aggregate. Thus, the grain shape of the recycled aggregate is inferior to that of natural aggregate, so that the appearance of the recycled aggregate is bad. Further, when the recycled aggregate is applied to a construction site, the coupling force between the surface of the aggregate and mortar is low, and the water absorption capacity of the recycled aggregate is high. Thereby, the strength of the recycled aggregate is reduced.

For these reasons, recycled aggregate is utilized as second-grade aggregate, so that the recycled aggregate is mixed with concrete to be used for concrete blocks, road structure foundations, gutters, catchment foundations, gravity-type retaining walls, gravity-type abutments, etc. Alternatively, recycled aggregate is utilized as third-grade aggregate, so that the recycled aggregate is mixed with concrete to be used for structures which do not require high strength, such as crude concrete, filling concrete, nonstructural concrete of a building, etc. Hence, it is impossible to utilize the recycled aggregate as first-grade aggregate which is used for bridge substructures and tunnel lining.

### SUMMARY OF THE INVENTION

Accordingly, the present invention has been made keeping in mind the above problems occurring in the prior art, and an object of the present invention is to provide a stripping device for recycled aggregate, which strips recycled aggregate, thus improving the quality of the recycled aggregate which is produced through a construction-waste processing operation.

Another object of the present invention is to provide a stripping device for recycled aggregate, which strips sludge, such as cement mortar or impurities, from the surface of the recycled aggregate obtained through a waste processing operation, using rotational and frictional action, thus improving the grain shape of the recycled aggregate, and reducing the water absorption capacity of the recycled aggregate, therefore allowing the recycled aggregate to be utilized as high quality first-grade aggregate.

In order to accomplish the above objects, the present invention provides a stripping device for recycled aggregate, including a hopper into which the recycled aggregate is input, a casing including an inlet hole provided at a predetermined position on the casing so that the aggregate dropping through the hopper is input into the inlet hole, an outlet hole provided at a position opposite the inlet hole so that the recycled aggregate is discharged through the outlet hole, and an uneven part provided on an inner circumferential surface of the casing, a rotary drum installed in the casing, and including a feed screw formed around the rotary drum to rotate and feed the recycled aggregate and an uneven part provided on an outer circumferential surface of the rotary drum, a drive means to drive the rotary drum, and a support leg to support the casing.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view of a stripping device for recycled aggregate, according to the first embodiment of the present invention;

FIG. 2 is a sectional view of the stripping device of FIG. 1;

FIG. 3 is a sectional view taken along line A-A of FIG. 2;

FIG. 4 is a sectional view of a stripping device for recycled aggregate, according to the second embodiment of the present invention, in which uneven parts of a casing and a rotary drum are different from those of the first embodiment;

FIG. 5 is a sectional view of a stripping device for recycled aggregate, according to the third embodiment of the present invention, in which a drive means engages with a chain;

FIG. 6 is a sectional view of the stripping device for recycled aggregate, according to the present invention, in which an inclination of the stripping device is different from that of FIG. 2; and

FIG. 7 is a sectional view of a stripping device for recycled aggregate, according to the fourth embodiment of the present invention, in which a hopper is supported by a housing.

### DESCRIPTION OF THE PREFERRED EMBODIMENTS

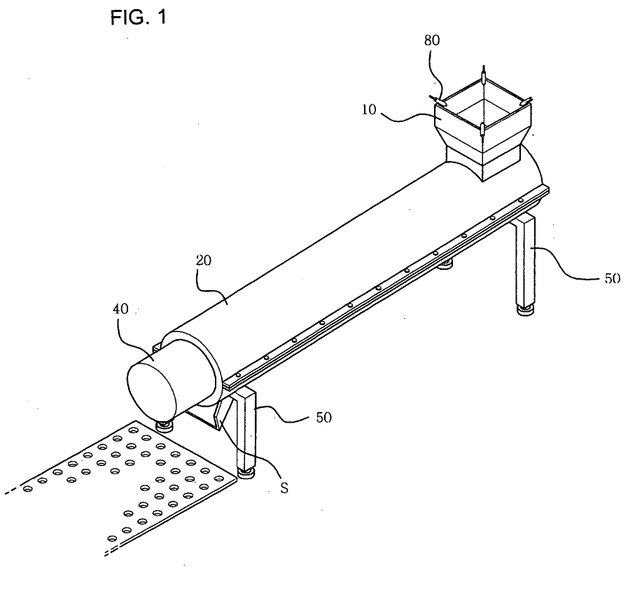

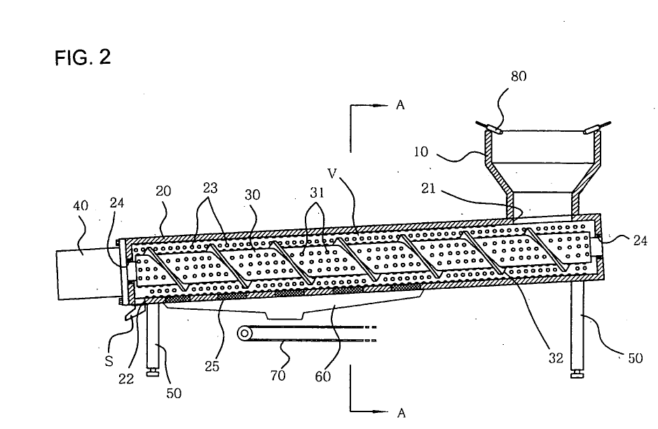

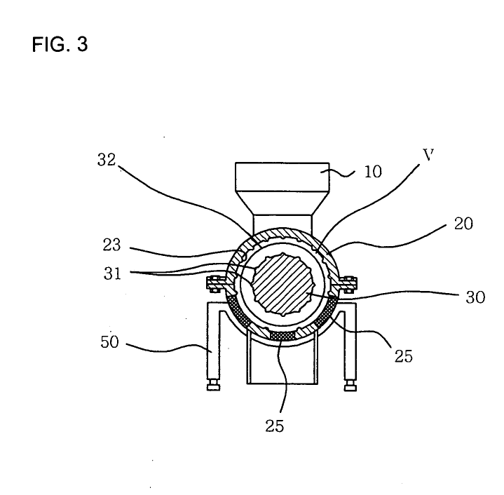

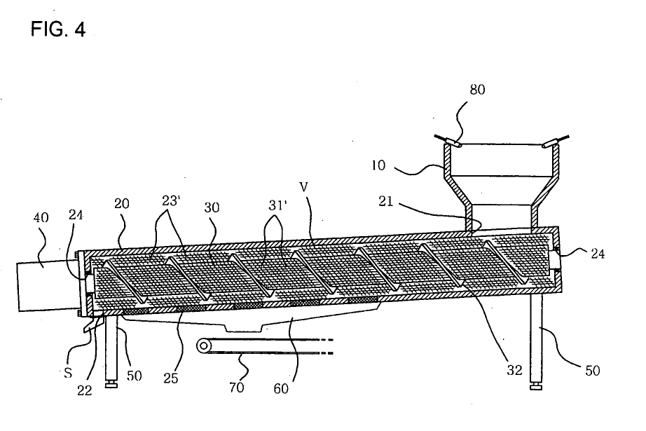

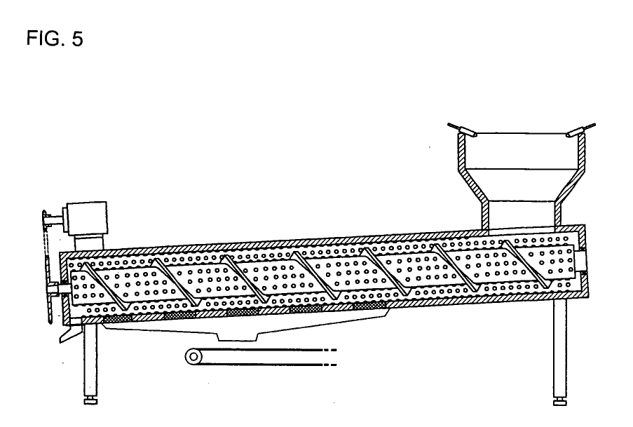

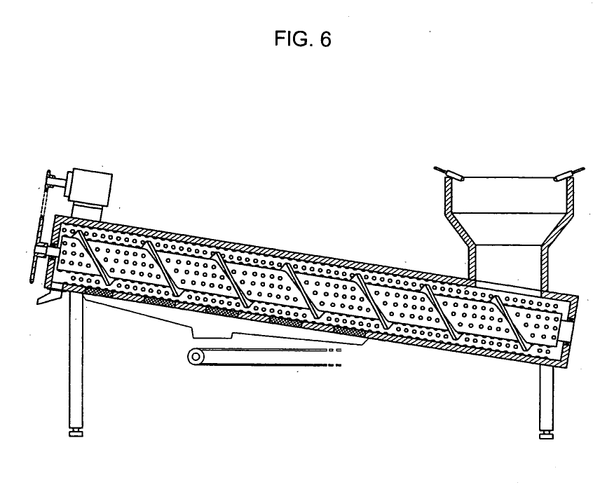

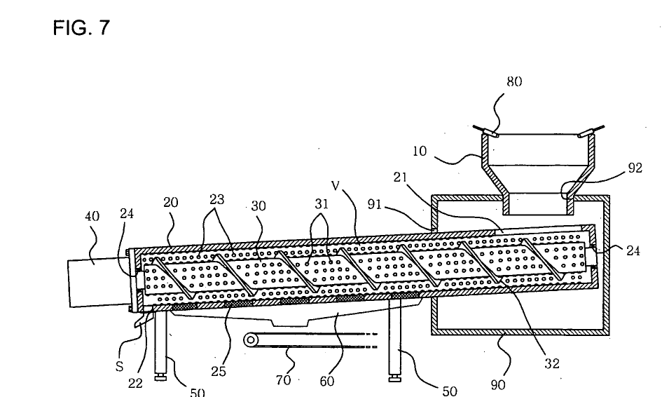

This invention will be described in further detail by way of example with reference to the accompanying drawings. FIG. 1 is a perspective view of a stripping device for recycled aggregate, according to the first embodiment of the present invention, FIG. 2 is a sectional view of the stripping device of FIG. 1, FIG. 3 is a sectional view taken along line A-A of FIG. 2, FIG. 4 is a sectional view of a stripping device for recycled aggregate, according to the second embodiment of the present invention, in which uneven parts of a casing and a rotary drum are different from those of the first embodiment, FIG. 5 is a sectional view of a stripping device for recycled aggregate, according to the third embodiment of the present invention, in which a drive means engages with a chain, FIG. 6 is a sectional view of the stripping device for recycled aggregate, according to the present invention, in which an inclination of the stripping device is different from that of FIG. 2, and FIG. 7 is a sectional view of a stripping device for recycled aggregate, according to the fourth embodiment of the present invention, in which a hopper is supported by a housing.

Referring to FIGS. 1 to 3, the stripping device for recycled aggregate includes a hopper 10, a casing 20, a rotary drum 30, a drive means 40, and support legs 50.

The waste processing operation, such as a crushing operation and a sorting operation, is executed to sort recycled aggregate having a predetermined grain size. The sorted recycled aggregate is input into the hopper 10. Although the waste processing operation is executed, sludge, such as cement mortar or impurities, remains on the surface of the aggregate. The sludge degrades the quality of the recycled aggregate. Thus, the recycled aggregate is second-grade or third-grade aggregate which is inferior in quality to natural aggregate. However, according to this invention, the sludge is removed from the surface of the recycled aggregate through rotational and frictional action of the stripping device that will be described in detail below. Thereby, the quality of the recycled aggregate is enhanced, so that the quality of the recycled aggregate is almost equal to that of first-grade aggregate, for example, natural aggregate.

The casing 20 includes an inlet hole 21, an outlet hole 22, and an uneven part 23. The inlet hole 21 is provided at a predetermined position on the casing 20 so that the recycled aggregate dropping through the hopper 10 is input into the inlet hole 21. The outlet hole 22 is provided at a position on the casing 20 opposite the inlet hole 21, so that the recycled aggregate is discharged through the outlet hole 22. The uneven part 23 is provided on an inner circumferential surface of the casing 20. Further, drum mounting holes 24 are provided on opposite ends of the casing 20 so that the rotary drum 30 is mounted to the casing 20 via the drum mounting holes 24.

The rotary drum 30 is installed in the casing 20 using the drum mounting holes 24 of the casing 20, with an uneven part 31 provided on an outer circumferential surface of the rotary drum 30. Further, a feed screw 32 is formed around the rotary drum 30 to feed the recycled aggregate. Such a construction allows the recycled aggregate to be fed while being rotated in a passage space V, thus maximizing the stripping efficiency for the recycled aggregate, in addition to preventing the recycled aggregate from being piled up on a lower portion of the casing 20.

In this case, the shapes of the uneven part 23 of the casing 20 and the uneven part 31 of the rotary drum 30 may be variously changed. That is, as shown in FIG. 2, the uneven parts 23 and 31 may comprise protrusions that protrude from the surfaces of the casing 20 and the rotary drum 30. Further, as shown in FIG. 4, the uneven parts 23 and 31 may comprise groove meshes 23′ and 31′. But, the uneven parts may have different shapes without being limited to the above-mentioned shapes. The heights of the uneven parts 23 and 31 comprising the protrusions may be variously modified or changed, depending on the state of recycled aggregate which is input into the stripping device.

Preferably, a screen 25 is provided at a predetermined position on the casing 20, so that fine powder separated from the recycled aggregate due to the frictional action of the stripping device passes through the screen 25. In this case, as shown in FIG. 3, it is preferable that the screen 25 be provided along the bottom and the opposite sides of the casing 20. That is, if the screen 25 is provided on only the bottom of the casing 20, the fine powder is deposited on the screen 25, so that the screen may be undesirably blocked. Thus, it is preferable that the screen 25 be provided on the opposite sides as well as the bottom of the casing 20. Thereby, as the recycled aggregate is rotated and moved in the casing 20, the separated fine powder is also rotated. The fine powder passes through the screen 25 to the outside. The fine powder obtained in this way is collected in a collecting container 60, and is discharged to a conveying means 70. Subsequently, the fine powder is conveyed to a predetermined place by the conveying means 70.

Preferably, a water jet nozzle 80 may be provided on an inlet of the hopper 10 to emit water. The water jet nozzle 80 sprays water on recycled aggregate input into the hopper 10, thus preventing dust from scattering while the recycled aggregate is input into the hopper 10. Further, the surface of the recycled aggregate contains moisture, thus allowing sludge to be easily removed from the surface of the recycled aggregate.

The drive means 40 is provided to drive the rotary drum 30. As shown in FIG. 2, the drive means 40 may be provided on a front portion of the rotary drum 30. Alternatively, the drive means 40 may be provided on a rear portion of the rotary drum 30. Further, as shown in FIG. 5, the drive means 40 may be supported by a support unit which is provided on an upper end of the casing 20, and a sprocket may be mounted to a shaft of the rotary drum 30. In this case, the rotary drum 30 is driven through a chain drive method.

The support legs 50 serve to support the casing 20. The number of support legs 50 may be increased or reduced, depending on the weight of the rotary drum 30 or the weight of the recycled aggregate to be treated. Further, it is preferable that the heights of the support legs 50 be adjustable so as to control the inclination of the casing 20 having the rotary drum 30 therein. By controlling the inclination of the casing 20, it is possible to adjust the period during which the recycled aggregate stays in the passage space, thus increasing or reducing the amount of sludge removed from the surface of the recycled aggregate. For example, when one desires to reduce the recycled aggregate treatment period, as shown in FIG. 2, the heights of the support legs 50 are adjusted so that the height of the casing 20 is lowered in a direction from the inlet hole 21 to the outlet hole 22. Conversely, when one desires to increase the recycled aggregate treatment period, as shown in FIG. 6, the heights of the support legs 50 are adjusted so that the height of the casing 20 is lowered in a direction from the outlet hole 22 to the inlet hole 21. As the recycled aggregate treatment period is increased, the amount of sludge removed from the surface of the recycled aggregate is increased. In this case, the heights of the support legs 50 may be adjusted using a hydraulic jack. Further, it is possible to adjust the heights of the support legs 50 through other conventional technology.

The hopper 10 may be directly supported by the casing 20. However, as shown in FIG. 7, the hopper 10 may be supported by a housing 90. Such a construction prevents dust from scattering, in addition to providing a good appearance. In a detailed description, a casing insertion hole 91 is provided on the front of the housing 90 so that the casing 20 is inserted into the casing insertion hole 91. Further, a hopper support hole 92 is provided on the top of the housing 90 so that the hopper 10 is inserted into and supported by the hopper support hole 92. That is, the hopper 10 is inserted into the hopper support hole 92, while the casing 20 is inserted into the casing insertion hole 91. Preferably, a predetermined gap is provided between the casing 20 and an upper edge of the casing insertion hole 91 provided on the front of the housing 90 to receive the casing 20. This gap prevents the housing 90 from interfering with the casing 20, when the heights of the support legs 50 are adjusted to control the inclination of the casing 20.

Hereinafter, the operation of the stripping device for recycled aggregate constructed as described above will be described.

First, the waste processing operation is executed to sort recycled aggregate having a predetermined grain size. The sorted recycled aggregate is input into the hopper 10. At this time, the recycled aggregate drops through the inlet hole 21 of the casing 21. While the recycled aggregate drops, water is sprayed from the nozzle 80, provided on the inlet of the hopper 10, onto the dropping aggregate, thus preventing dust from scattering. Further, the surface of the recycled aggregate contains moisture, thus allowing sludge to be more easily removed from the recycled aggregate when the following rotational and frictional action is carried out.

The recycled aggregate dropping through the inlet hole 21 is fed to the annular passage space V which is defined between the inner circumferential surface of the casing 20 and the outer circumferential surface of the rotary drum 30. At this time, the rotary drum 30 is rotated by the driving force of the drive means 40, so that the recycled aggregate is rotated and moved by the feed screw 32 of the rotary drum 30. While the recycled aggregate is rotated and fed, the recycled aggregate rubs against the uneven part 23 of the casing 20 and the uneven part 31 of the rotary drum 30, so that a surface is stripped from the recycled aggregate. Further, the surface may be stripped from the recycled aggregate due to the friction between pieces of the recycled aggregate. Such a stripping operation removes sludge from the surface of the recycled aggregate, thus preventing the grain shape of the recycled aggregate from being poor due to the sludge, and reducing the water absorption capacity of the recycled aggregate, therefore obtaining recycled aggregate of high quality. Thus, the recycled aggregate can be utilized as first-grade aggregate. Finally, the recycled aggregate is discharged through the outlet hole 22 and an outlet chute S, and thereafter is sorted by a sorter according to size.

Meanwhile, when a large amount of sludge is adhered to the recycled aggregate, the heights of the support legs 50 are adjusted. Thereby, the inclination of the casing 20 is changed, as shown in FIG. 6, to increase the period during which the recycled aggregate stays in the passage space V. Therefore, high quality recycled aggregate can be obtained.

Further, while a surface of the recycled aggregate is stripped, fine powder is produced. The fine powder passes through the screen 25 which is provided on the lower portion of the casing 20. Subsequently, the fine powder is collected in the collecting container 60, and thereafter is discharged to the conveying means 70. Afterwards, the fine powder is conveyed to a predetermined place by the conveying means 70.

As described above, the present invention provides a stripping device for recycled aggregate, which strips sludge, such as cement mortar or impurities, from the surface of recycled aggregate obtained through a waste processing operation, using rotational and frictional action, thus preventing the grain shape of the recycled aggregate from being poor due to the sludge, and reducing the water absorption capacity of the recycled aggregate, therefore allowing the recycled aggregate to be utilized as high quality first-grade aggregate.

What is claimed is:

1. A stripping device for recycled aggregate, comprising:
a hopper into which the recycled aggregate is input;
a casing, comprising:
an inlet hole provided at a predetermined position on the casing so that the aggregate dropping through the hopper is input into the inlet hole;
an outlet hole provided at a position opposite the inlet hole so that the recycled aggregate is discharged through the outlet hole; and
an uneven part provided on an inner circumferential surface of the casing;
a rotary drum installed in the casing, and comprising:
a feed screw formed around the rotary drum, thus rotating and feeding the recycled aggregate; and
an uneven part provided on an outer circumferential surface of the rotary drum;
drive means to drive the rotary drum; and
a support leg to support the casing.

2. The stripping device as set forth in claim 1, wherein the casing further comprises:
a screen to discharge sludge removed from the recycled aggregate.

3. The stripping device as set forth in claim 2, wherein the screen is provided along a bottom and a side of the casing.

4. The stripping device as set forth in claim 1, wherein a water jet nozzle is provided on an inlet of the hopper to spray water onto the recycled aggregate input into the hopper.

5. The stripping device as set forth in claim 1, wherein the support leg is constructed so that a height thereof is adjustable, thus controlling an inclination of the casing.

6. The stripping device as set forth in claim 5, further comprising:
a housing, comprising:
a casing insertion hole provided on a front of the housing so that the casing having the rotary drum therein is inserted into the casing insertion hole; and
a hopper support hole provided on a top of the housing so that the hopper is inserted into and supported by the hopper support hole.

7. The stripping device as set forth in claim 6, wherein a gap is provided between the casing and an upper edge of the casing insertion hole, thus preventing the housing from interfering with the casing, when the inclination of the casing is controlled by adjusting the height of the support leg.
